(19) United States
(12) Patent Application Publication
(10) Pub. No.: US 2004/0205160 A1
(43) Pub. Date: Oct. 14, 2004

(54) Method for managing communications

(75) Inventor: Pierre-Alain Cotte, Amberg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: WEB DE AG, Karlsruhe (DE)

(21) Appl. No.: 10/410,622

(22) Filed: Apr. 9, 2003

(51) Int. Cl. G06F 15/16

(52) U.S. Cl. 709/218

(57) ABSTRACT

A method for managing communications includes communicating, from a first end user unit, data indicating a second end user unit. The data indicating the second end user unit is configured to initiate a communications link with the second end user unit. The data indicating the second end user unit is routed to a web site associated with the second end user unit.

### BACKGROUND

In general, the present invention relates to communications between end user units in a communications environment. In particular, the present invention relates to the management of communications between end user units using a general-purpose communications interface referred to herein as a telecommunications web site.

Communications environments such as Public Switched Telephone Network (PSTN)-based networks, Integrated Services Digital Network (ISDN) networks, cellular networks, etc., provide so-called “call-forwarding” services. Call-forwarding services enable a user to have communications links, for example telephone calls, which are originally intended for an end user device chosen by a calling end user device, are directed to a different end user device. As a result, the calling end user device will be connected to an end user device different from the end user device the calling end user device has called.

### SUMMARY OF THE INVENTION

Call-forwarding services are usually restricted to the communications environment of the provider of such a service. Call-forwarding between different communications environments is generally not possible.

Further, capabilities of call-forwarding services heavily depend on the infrastructure of the used communications environment and, thus, cannot be easily adapted.

Further, due to the dependence on the communications environment infrastructure call-forwarding services are usually only provided by communications environments operators and providers or at least partially controlled thereby.

Improved management of communications in a communications environment with respect to re-directing, routing, or forwarding, of communications links is needed. In particular, solutions are needed that make such management of communications or communications links more flexible, user-friendly, adaptable to different communications environments, that reduce dependence on communications environment network structures, and that mitigate constraints and limitations imposed by communications environment service providers and operators.

The present invention provides a method for managing communications. The method includes communicating from a first end user unit data indicating a second end user unit and configured to initiate a communications link with the second end user unit; and routing the data indicating the second end user unit to a web site associated with the second end user unit.

The web site may be a telecommunications web site associated with the second end user unit. The data indicating the second end user unit may be stored using the web site.

The method may include defining, using the second end user unit, a routing directive for routing the data indicating the second end user unit to the web site. Routing the data indicating the second end user unit may be performed by communicating the data indicating the second end user unit from the first switching unit to the web site. Moreover, the method may include directing, using the second end user unit, that communications links are to be forwarded to a third end user unit; and establishing a communications link from the first end user unit to the third end user unit using the web site.

The present invention also provides a web site for managing communications. The web site includes a web page associated with a user of a second end user unit and a processor. The processor is configured to receive, from a first end user unit, data indicating the second end user unit, the data being communicated from a first end user unit and being configured to initiate a communications link with the second end user unit.

A communications control unit is also provided by the present invention. The communications control unit includes a processor configured to: control communications links between end user units; receive from a web site data indicating the third end user unit, the third end user unit being an end user unit to which communications intended for a second end user unit are to be routed; and communicate the data indicating the third end user unit to a switching unit. The switching unit is configured to receive data indicating the second end user unit and replace the data indicating the second end user unit with data indicating the third end user unit so as to establish a communications link from the switching unit to the third end user unit.

A communications management unit is also provided by the present invention. The communications management unit includes a processor configured to: control a communications control unit; receive from a web site the data indicating a third end user unit; and communicate the data indicating the third end user unit to the communications control unit switching unit. The communications control unit is configured to control communications links between end user units and to communicate to a switching unit data indicating the third end user unit, the third end user unit being an end user unit to which communications intended for a second end user unit are to be routed. The switching unit is configured to receive data indicating the second end user unit and replace the data indicating the second end user unit with data indicating the third end user unit so as to establish a communications link from the switching unit to the third end user unit.

Also provided by the present invention is a computer readable medium having stored thereon computer executable process steps operative to perform a method for managing communications. The method includes communicating from a first end user unit data indicating a second end user unit and configured to initiate a communications link with the second end user unit; and routing the data indicating the second end user unit to a web site associated with the second end user unit.

The present invention overcomes problems and constraints of known approaches to communications management, and enables management of communications in a flexible and user-friendly manner that is adaptable to different communications environments and that mitigates limitations imposed by communications environment service providers and operators.

### BRIEF DESCRIPTION OF THE DRAWINGS

In the following description, the present invention is elaborated upon based on exemplary embodiments, with reference to the drawings.

FIG. 1 shows a schematic diagram of a communications environment for carrying out, using a telecommunications web site, management of a communications link from a first end user unit to a second end user unit, according to a first embodiment of the present invention.

FIG. 2 shows a schematic diagram of a communications environment for carrying out, using a telecommunications web site, management of a communications link from a first end user unit to a second end user unit using a telecommunications web site, according to a second embodiment of the present invention.

FIG. 3 shows a schematic diagram of a communications environment for carrying out, using a telecommunications web site, management of a communications link from a first end user unit to a second end user unit using a telecommunications web site, according to a third embodiment of the present invention.

FIG. 4 shows a schematic diagram of a communications environment for carrying out, using a telecommunications web site, management of a communications link from a first end user unit to a second end user unit using a telecommunications web site, according to a fourth embodiment of the present invention.

FIG. 5 shows a schematic diagram of a communications environment for carrying out, using a telecommunications web site, management of a communications link from a first end user unit to a second end user unit using a telecommunications web site, according to a fifth embodiment of the present invention.

FIG. 6 shows a schematic diagram of the architecture of a communications environment for carrying out, using a telecommunications web site, management of a communications link according to an embodiment of the present invention.

### DETAILED DESCRIPTION

In an embodiment the present invention provides a method for communications management wherein, originating from a first end user unit, data indicating a second end user unit are communicated. Such data can be, for example, a telephone number, a Uniform Resource Locator (URL), an Internet address, or other suitable identifier or addressing information. The data indicating the second end user unit can be communicated by transmitting within a communications network such as a PSTN-based or mobile cellular telephone network, a computer-based network, the Internet, etc., using wired, wireless, optical, infrared, digital, analog, etc.

Independently of the type of data used for indicating or characterizing the second end user unit and the manner these data are communicated, the data indicating the second end user unit are routed to a telecommunications web site that is associated, preferably uniquely, with the second end user unit.

Management of communications between end user units and, in particular, management of communications links between end user units in a communications environment are accomplished on the basis of data which are communicated or transferred from a calling end user unit to a called end user unit and which indicate or characterize the called end user unit.

A communication link may be any communications connection, path, etc., providing communications between end user units.

In a general, two transmission approaches may be implemented in a communications environment:

According to a first approach, data indicating a called end user device and data and/or information to be communicated between the calling end user device and the called end user device are connected, for example in a data stream or communications channel. The data and/or information to be communicated represent content such as voice data, video data, alphanumerical data, etc.

According to a second approach, data indicating a called end user device and content to be communicated between the calling end user device and the called end user device are separated, for example in separated data streams or channels.

For re-directing communications links to be established to a called end user unit as defined by a calling end user unit, the end user unit to be called, or its user, defines a different end user unit to which incoming communications links are to be re-directed. To re-direct incoming communications links, information characterizing the end user unit to which the incoming link is to be routed is obtained. Such identification information is analogous to the above data indicating the second end user unit.

In the above first approach, data indicating a second end user unit can be obtained as separate data. But for actually re-directing or routing a communications link originating from the first end user unit, it is not possible to use only the data indicating the second end user device and to re-direct an associated communications link. Rather, an actual re-directing of a communications link to a different end user unit instead of the second end user unit requires an establishment of a communications link to a unit responsible for the re-directing, i.e., the telecommunications web site. As a result, such a re-directing of communications links will usually result in communications link costs due to the establishment of a communications link to the telecommunications web site.

In contrast thereto, according to the above second approach a re-directing of communications links does not require an establishment of a communications link to the telecommunications web site since the data indicating the second end user unit and content data/information intended to be communicated thereto are separated and, thus, can be used separately.

An example of the above first approach includes an ISDN telephone network utilizing the SS7-ISUP protocol. According to the SS7-ISUP protocol, signaling analogous to the above data indicating the second end user device and a content channel (e.g., voice channel) associated thereto are connected. As a result, re-directing/routing/forwarding the signaling will also result in an establishment of the associated content channel.

An example of the above second approach includes an intelligent network (IN) utilizing the SS7-INAP protocol. According to the SS7-INAP protocol, routing information comparable to the above data indicating the second end user unit are clearly separated from content data and/or information to be communicated such as voice data.

The method according to the present invention enables the telecommunications web site to perform a re-directing/routing/forwarding of communications links networks using both approaches, as will be described below.

An end user unit as used herein refers to any of a variety of devices or units which can be used for communications. For example, an end user unit may be a telephone, a keyboard, a computer terminal, a mobile phone, a fax, a telex, a mail pigeon, an ordinary letter, a scanner, a PSTN device, a Third Generation (3G) wireless communications device, especially a Universal Mobile Telecommunications System (UMTS) device, etc., or a combination of two or more of these.

The end user unit of the present invention is not limited to a particular communications unit/device or any communications network. Rather, communications using an end user unit can occur via any of a variety of communications networks such as telephone networks, mobile communications networks, computer networks, radio transmission networks, the Internet, etc. Further, as noted above, an end user unit is not restricted to a single device, but can also include two and more devices providing data/information sending and/or receiving capabilities for communications purposes.

The end user unit is adapted to perform network-based communications. Thus, the end user unit is connectable to a network and able to communicate with a network. A network in this context is a physical transport medium in which data and/or signals can be fed. For example, an ordinary letter itself is adapted to perform network-based communication when scanned or digitized and supplied into a TCP/IP network.

A communications environment may be a communications system comprising more than one component, i.e., more than one device and/or type of device, media and/or type of media, network and/or type of network. Thus, a communications environment or communications system might for instance comprise a telephone, a PSTN-network, a gateway to the Internet, etc.

A communications link may be any communications connection via which information can be exchanged.

A web site and a web page may be, respectively, a site and sub-site associated with the web page, both of which can be uniquely addressed using a single address, like a telephone number or an Internet Protocol (IP) address, an URL, etc. A web site may be used in a 3G-communication environment, especially a UMTS environment. A web site may be a site on the Internet with a specific URL, such as a site on the World Wide Web, which can be accessed by Internet visitors, and by the web site host. The web site host is the owner of the web site.

This web site may include one or more web pages. These web pages are part of the one web site. It should be noted that the terms “web site” and “web page” are not to be considered to limit the present invention to conventional Internet web sites and web pages. Thus, the web site and its web page(s), respectively, may be accessed by establishing a communications link from an end user unit independently of the network(s) employed.

A telecommunications web site may be a web site adapted to provide, upon an access by an end user unit, for private communications between the accessing end user unit and an end user unit to which a communications link is to be established. Properties and functions of a telecommunications web site are described in commonly-assigned U.S. patent application Ser. No. 10/201,446, entitled “Communications Environment,” filed Jul. 23, 2002, and in commonly-assigned U.S. patent application Ser. No. 10/354,709, entitled “Web Site Having an Event Identification Element,” filed on Jan. 29, 2003, both of which are hereby incorporated by reference herein.

The terms “telecommunications web site” and “web site” may be understood to encompass software and hardware components effecting the site. Such components may include one or more processors and/or memories, for example.

A telecommunications web site is assigned to or personalized for or corresponds to a specific person or entity. Such a specific entity can be a person, a company or any other entity. Preferably, the specific entity is a single entity, e.g., a specific user or owner (e.g., a single person, a company, a unit of a company, etc.) of the telecommunications web site, a specific address, a specific location, a specific end user unit and the like. Thus, an end user unit of a user to whom a telecommunications web site is associated to will be also associated with that telecommunications web site if used for accessing the telecommunications web site. Therefore, the specific entity with which a telecommunications web site is associated and an end user unit employed by the specific entity can in some embodiments be considered as synonymous for the period of time the specific entity operates its end user unit to access its telecommunications web site.

A telecommunications web site serves as a general-purpose communications interface for an end user unit or an addressed entity, which may include or be an end user unit itself. As an illustration, the telecommunications web site can be considered as a communications “window”, similar to a window of an office counter, where communicating parties are “sitting” on opposite sides of the window and can communicate through speech holes in the window, via an intercom, by gestures, by facial expressions, showing papers with information written thereon, passing documents through a hatch and so on. Comparable thereto, the telecommunications web site according to the present invention allows communications in a plurality of modes and by a plurality of types/formats of data/information.

A telecommunications web site may be capable of providing and establishing multi-protocol communications, i.e., communications using different types of communications links. A multi-protocol connection may include different types of communications links, such as links of PSTN networks, UMTS networks, Transmission Control Protocol/Internet Protocol (TCP/IP)-based networks, etc. For example, the connection of a telephone in a PSTN network to a UMTS device in a UMTS network includes is a multi-protocol connection. Such a connection in parallel with a connection of a computer in a TCP/IP-based network to another computer in a TCP/IP-based network is also a multi-protocol connection as herein defined. Thus, a parallel use of different types of communications links is a multi-protocol connection. The individual links may carry various types of communications media (voice, data, video, etc.).

The data indicating the second end user unit may be communicated directly to the telecommunications web site or to a first switching unit. Examples of a switching unit include PSTN switchboards for analog and/or digital telephone links, network routers, network nodes, radio base stations for a cellular telephone network, satellite based relay units, transceivers, etc.

When communicated via a switching unit, the data indicating the second end user unit are transmitted from the first switching unit to the telecommunications web site.

The data indicating the second end user unit may be stored using the telecommunications web site, for example in a memory associated thereto. This enables the second end user unit to access the stored data indicating the second end user unit for later use and retrieval in order to, for example, to be informed that the first end user unit tried to establish a communications link to the second end user unit. As will be explained below, the stored data indicating the second end user unit can also be used for establishing a communications link as intended by the first end user unit but under control of the telecommunications web site.

For routing or re-directing the data indicating the second end user unit to the telecommunications web site instead of the second end user unit, a routing constraint, or directive, can be defined, for example using the second end user unit.

In a communications environment using the above first transmission approach, to route or re-direct the communications link intended by the first end user unit to an end user unit being different from the second end user unit, a communications link from the first end user unit is established via the telecommunications web site to a third end user unit. The third end user unit represents an end user unit to which the intended communications link is to be directed instead of the second end user unit. In an embodiment, the third end user unit is selected by the second end user unit, for example by providing respective data/information to the telecommunications web site.

Due to the establishment of the communications link from the first end user unit to the telecommunications web site and, in particular if this communications link is established via the first switching unit, communications link costs can occur. Depending on the accounting method employed in the relevant communications environment, such communications link costs can be charged to the first end user unit, to the telecommunications web site, the second end user unit or the third end user unit.

Depending on the type of the third end user unit, its communications environment and the like, it is possible that the telecommunications web site establishes the communications link to the third end user unit via a second switching unit.

One way of avoiding the above routing-related additional communications link costs is to obtain data indicating the first end user unit using the telecommunications web site. On the basis of such data, the telecommunications web site can establish a communications link to the first end user unit. As a result, the communications link between the first end user unit and the telecommunications web site is not a communications link from the first end user unit re-directed or routed via the telecommunications web site. Rather this communications link is analogous to a conventional communications link, which usually does not result in communications link costs related to a re-directing or routing service. Further, the telecommunications web site establishes a communications link to a third end user unit. As above, the third end user unit, which can be selected by the second end user unit, represents an end user unit to which a communications link originally intended for the second end user unit is to be forwarded. In order to actually establish a communications link between the first and the third end user units, the telecommunications web site connects the communications links to the first end user unit and the third end user unit.

Where the first end user unit connects to the telecommunications web site via the first switching unit, the data characterizing the first end user unit is in an embodiment obtained via the first switching unit. Then, both the communications link to the first end user unit and the communications link to the third end user unit may be established via the first switching unit.

With or without using a first switching unit, the communications links to the first and third end user units are in an embodiment established via a second switching unit.

In an embodiment, the re-directing or routing of the communications link intended by the first end user unit to the third end user unit includes a replacement in the first switching unit of the data indicating the second end user unit by data indicating the third end user unit. This can be accomplished under control of the telecommunications web site. Then, the communications link to the third end user unit will be established on the basis of the data indicating the third end user unit.

Where the communications environment employs the above-described second transmission approach, in order to provide for a re-directing/routing/forwarding of a communications link from the first end user unit to a third end user unit instead of the second end user unit, the telecommunications web site communicates data indicating the third end user to a switching unit. As described above, the third end user unit represents an end user unit to which communications links are to be routed, instead of the second end user unit as originally intended by the first end user unit. Preferably, the definition of the third end user unit and the provision of respective data are performed under control of the second end user unit. As described above, the switching unit may be a PSTN switchboard for analog and/or digital telephone links, network router, network node, radio base station for a cellular telephone network, satellite based relay unit, transceiver, etc.

Further, the data indicating the second end user unit are communicated from the first end user unit to the switching unit. This communication can be performed at the same time or subsequently to the routing of the data indicating the third end user unit to the telecommunications web site. Moreover, communicating of the data indicating the third end user unit from the telecommunications web site to the switching unit can be performed before the data indicating the second end user unit are routed to the telecommunications web site or in response to the routing of the data indicating the second end user unit.

Then, the data indicating the second end user unit are replaced using the switching unit by the data indicating the third end user unit such that the communications link originally intended to the second end user unit will be established to the third end user unit.

This latter-described embodiment of the method according to the present invention is possible because in the above-described second transmission approach data indicating the second end user unit, for example in form of signaling, is separated from content transmitted from the first end user unit.

In order to provide for a re-directing/routing/forwarding of communications links in the context of the above-described second transmission approach, the present invention provides in an embodiment an alternative method for managing communications with a first end user unit. Again, a telecommunications web site associated with a second end user unit communicates data indicating a third end user unit to a switching unit. In contrast to the above described embodiments, in this embodiment data indicating a second end user unit are not routed to the telecommunications web site. Rather, the first end user unit communicates data indicating the second end user unit to the switching unit. Again, the communicating of the data indicating the third end user unit may be carried out before or in response to the communicating of the data indicating the second end user unit by the first end user unit.

Then, using the switching unit, the data indicating the second end user unit are replaced by the data indicating the third end user unit. As a result, a communications link originally intended for the second end user unit will be established with the third end user unit. Because in the above-described second transmission approach data indicating the second end user unit, for example in form of signaling, is separated from content transmitted from the first end user unit, communications links are in some embodiments established from the switching unit to the first end user unit and to the third end user unit, and these communications links are connected to actually provide for a communications link between the first and third end user units.

For communicating the data indicating the third end user unit, in an embodiment the telecommunications web site communicates this data to a communications control unit, via a local switching unit, for example. The communications control unit may be, for example, a Service Control Point (SCP) in an intelligent network utilizing the SS7-INAP protocol. The communications control unit controls communications links between end user units. The received data are communicated from the communications control unit to the switching unit so as to instruct the switching unit to re-direct/route/forward communications links originally intended to the second end user unit to the third end user unit. The communications control unit may be capable of controlling the switching unit to replace the data indicating the second end user unit by the data indicating the third end user unit upon the receipt, by the switching unit, of the data indicating the second end user unit.

In a communications environment where communications control units are controlled by communications management units, according to the present invention the data indicating the third end user unit are communicated from the telecommunications web site to a communications management unit. The communications management unit may be, for example, a Service Management Point (SMP) in an intelligent network utilizing the SS7-INAP protocol. The received data are communicated by the communications management unit to a communications control unit, described above. Subsequently, the data indicating the third end user unit are communicated using the communications control unit to the switching unit to instruct the switching unit that communications links intended for the second end user unit are re-directed/routed/forwarded to the third end user unit. The communications control unit may be capable of controlling the replacing of the data indicting the second end user unit by the data indicating the third end user unit as carried out by the switching unit. The communicating of the data indicating the third end user unit from the telecommunications web site to the switching unit may be communicated in real-time in response to the communication of the data indicating the second end user unit. Communication of the data indicating the second end user unit to the telecommunications web site and/or to the switching unit may also be performed in real-time. Furthermore, communications from the telecommunications web site to a communications control unit, from the communications control unit to a communications management unit, and from a communications management unit to a communications control unit may be real-time communications.

In intelligent networks utilizing the SS7-INAP protocol, SCPs control the routing of communications links. SCPs receive from a (local) switching unit the separate data characterizing a called end user unit. On the basis of the characterizing data, the communications control units determine whether a call forwarding for the respective end user unit is requested. If this is the case, communications control units route the communications link originally intended for an end user unit to a different end user unit.

For controlling such a communications control unit, a communications management unit, such as an SMP according to the SS7-INAP protocol, may be used. Such communications management units are used for providing information concerning a requested communications links routings and the like to communications control unit. Usually communications and/or transmission links between communications management units and communications control units do not provide for a real-time transmission, but are nevertheless possible.

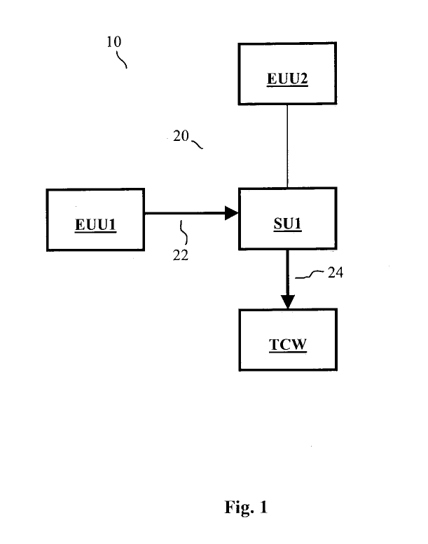

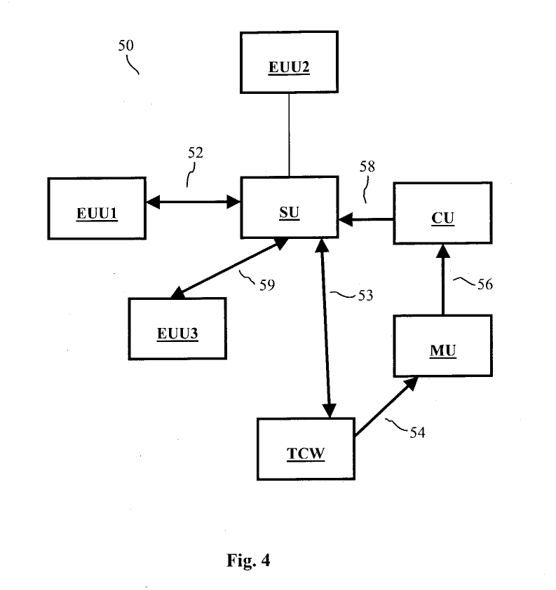

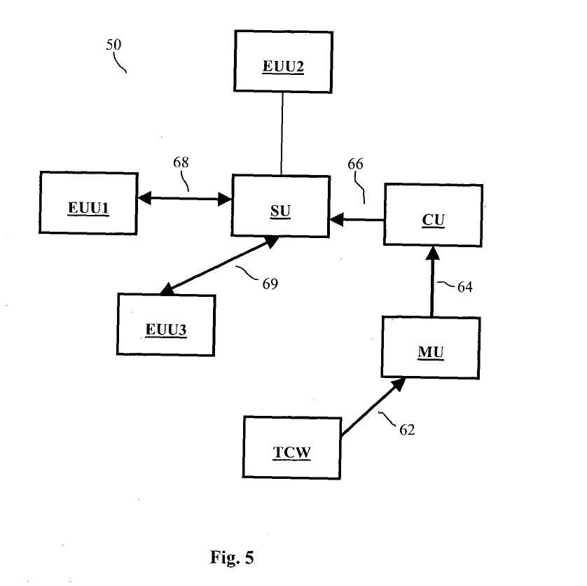

In the following, embodiments of the method according to the present invention are described in which a telephone network is used as communications environment. In the embodiments described with reference to FIGS. 1-3, the SS7-ISUP protocol is used. In the embodiments described with reference to FIGS. 4-5, the SS7-INAP protocol is used. For the sake of simplicity, in the following, end user units are telephones, switching units are switchboards, communications control units are SCPs and communications management units are SMPs. Of course, other suitable respective devices may serve as these units.

For the embodiments illustrated in FIGS. 1, 2 and 3, a standard call-forwarding service is employed in the telephone network. Thus, local switching units of the telephone network can be controlled such that, for each end user unit (in these embodiments a respective telephone) a communications link (e.g., telephone call) directed to the end user unit is forwarded to a different end user unit. The telephone network and end user units may be analog and/or digital.

For initiating a call-forwarding service, a user of an end user unit transmits, to a respective switching unit, data characterizing a different end user unit to which communications links are to be forwarded. This transmitting of the data may be performed using the end user unit for which the call-forwarding service is requested or using a different unit, such as a personal computer or a different telephone.

According to the SS7-ISUP protocol, signaling and associated content data/information are inseparably connected. Thus, data characterizing an end user unit to be called and content data/information are transmitted in combination. While a transmission of signaling is usually not connected with communications link costs for the participating end user units, the transmission of content data and/or information such as voice data will be performed via a communications link for which costs occur.

Therefore, call-forwarding in the context of the SS7-ISUP protocol will lead to communications link costs in addition to those arising for a conventional communications link. Such disadvantages with using the SS7-ISUP protocol and to provide for a basic communications link management can be overcome using the embodiment of the method according to the present invention shown in FIG. 1. This embodiment provides for communications link management including a monitoring of communications links intended for a receiving end user unit.

Referring now to FIG. 1, first end user unit EUU1, second end user unit EUU2, switching unit SU1 and telecommunications web site TCW are part of communications environment 10. First end user unit EUU1 represents a calling end user unit, while second end user unit EUU2 represents an end user unit to which first end user unit EUU1 desires to be connected. First end user unit EUU1 initiates a communications link to second end user unit EUU2 by transmitting a telephone number of second end user unit EUU2 to indicate a desired telephone connection thereto. The telephone number is transmitted to switching unit SU1 over telephone network 20 via communications path 22.

Second end user unit EUU2 or its user has instructed switching unit SU1 to redirect, route, or forward, to telecommunications web site TCW incoming communications links for, or incoming requests to establish a communications link with, second end user unit EUU2. In providing this instruction to switching unit SU1, second end user unit EUU2 defines a “routing directive.” Telecommunications web site TCW is associated with second end user unit EUU2. This routing directive by second end user unit EUU2 is for the purpose of providing management of communications. Specifically, the management of communications is here a monitoring of communications links. Such a monitoring of communications links may be desirable, for example, where a user of the second end user unit EUU2 is absent.

In defining the routing directive, second end user unit EUU2 in an embodiment instructs switching unit SU1 to route incoming communications to telecommunications web site TCW by communicating with the switching unit using SS7 protocols, such as ISUP (ISDN User Part as defined by ITU-T Recommendations Q.761, Q.762, Q.763, Q.764), for example, or other protocols, depending on the type of switching unit SU1. In other embodiments, second end user unit EUU2 may instruct switching unit SU1 via telecommunications web site TCW. Moreover, second end user unit EUU2 may instruct switching unit SU1 before, upon or after the incoming communications from first end user unit EUU1.

In an embodiment, the routing directive employs features of ISUP, including the following: CFB (Call Forwarding Busy), CFNR (Call forwarding No Reply), CD (Call Deflection), ECT (Explicit Call Transfer) and CTN (Call Transfer Normal). The maximum number of call transfers is limited to five by ETSI (European Telecommunications Standards Institute), but a network operator may only permit fewer. For network transitions, the redirect counter should be transferred transparently. Further details regarding messages for performing the above features is provided in ITU-T Recommendations Q.761, Q.762, Q.763 and Q.764, which are hereby incorporated by reference herein.

Upon receipt of incoming data from first end user unit EUU1 indicating second end user unit EUU2, switching unit SU1 routes the data to telecommunications web site TCW over communications link 24. Since the SS7-ISUP protocol is being used, both the data characterizing second end user unit EUU2 and the respective content are forwarded to telecommunications web site TCW. In order to avoid communications link costs, telecommunications web site TCW obtains the data characterizing second end user unit EUU2 but refuses an actual establishment of a communications link, i.e., here a telephone connection, to first end user unit EUU1. This refusal by telecommunications web site TCW is analogous to a user of a conventional telephone refusing an incoming telephone call by not picking up the handset of the telephone.

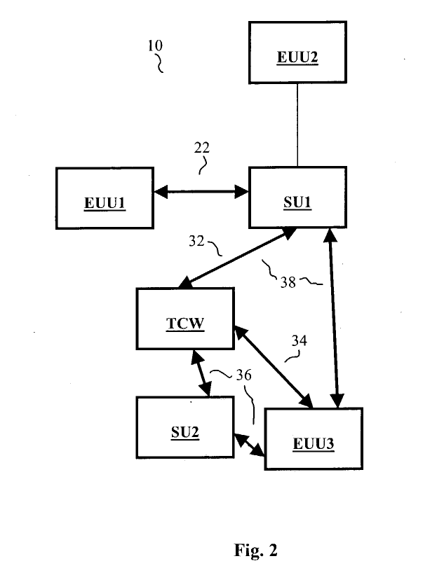

Referring now to FIG. 2, a forwarding of a communications link originally intended for second end user device EUU2 is to be carried out. According to this embodiment, the communications link forwarding is defined to provide for communications links destined for second end user unit EUU2 to instead be routed to third end user unit EUU3.

As with the embodiment shown in FIG. 1, in FIG. 2 first end user unit EUU1 communicates data characterizing second end user unit EUU2 and, due to use of the SS7-ISUP protocol, associated content, to switching unit SU1 over communications link 22. Switching unit SU1 has been instructed to direct to telecommunications web site TCW communications bound for second end user unit EUU2. Switching unit SU1 therefore routes the data and/or information received from first end user unit EUU1 to telecommunications web site TCW over communications link 32.

In contrast to known call-forwarding services that would effect a forwarding of a call completely using switching unit SU1, communications link routing to third end user unit EUU3 is, according to an embodiment of the present invention, controlled by telecommunications web site TCW. For that purpose, second end user unit EUU2 has accessed associated telecommunications web site TCW and instructed the web site that incoming communications links for second end user unit EUU2 are to be routed to third end user unit EUU3.

To instruct telecommunications web site TCW using end user unit EUU2, in an embodiment a user first calls telecommunications web site TCW using his telecommunications web site telephone number. The user then uses keys on a dial pad of second end user unit EUU2 to enter a personal identification number (PIN) for identification and authorization. Then the user enters a telephone menu and activates the desired functions by typing a combination of numbers to identify the action (e.g., unconditional call forwarding UCF as described in SS7/ISUP) and parameters (e.g., a destination number), followed by, e.g., the “#” sign to signal the end of the setup process.

Upon receipt of data and/or information from switching unit SU1, telecommunications web site TCW accepts the communications link (analogous to a picking up of a handset upon receiving a telephone call). As a result, a communications link between first end user unit EUU1 and telecommunications web site TCW is established. On the basis of respective routing information or constraints of the communications link originally directed to second end user unit EUU2, telecommunications web site TCW establishes communications link 34 to third end user unit EUU3. In another embodiment, telecommunications web site TCW establishes communications link 36 to third end user unit EUU3 over switching unit SU2. Moreover, in yet another embodiment, telecommunications web site TCW establishes communications link 38 to third end user unit EUU3 via switching unit SU1.

In the embodiment depicted in FIG. 2 the use of the telecommunications web site TCW enables user-friendly, enhanced communications link management that is not restricted to a specific communications environment, is independent of a service provider or operator of the communications environment, and is independent of first switching unit SU1. This embodiment provides communications link management in the form of routing of communications links.

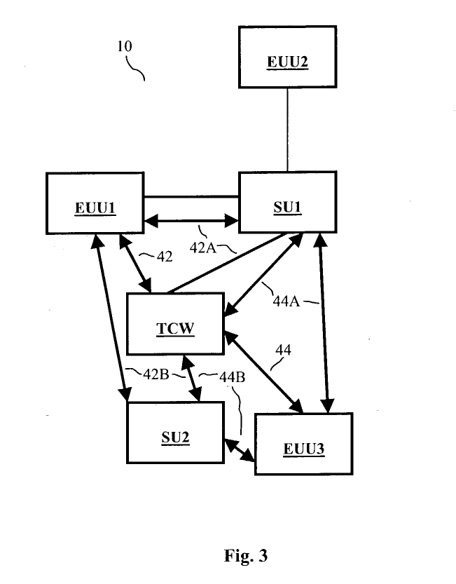

As with the embodiment shown in FIG. 1, the embodiment illustrated in FIG. 3 provides an advantageous avoiding of unnecessary communications link costs. Additionally, the embodiment shown in FIG. 3 provides an actual forwarding of incoming communications links, as with the embodiment depicted in FIG. 2. Like the embodiment illustrated in FIG. 1, in FIG. 3 telecommunications web site obtains data characterizing second end user unit EUU2 but does not establish a communications link via switching unit SU1 to first end user unit EUU1. Thus, additional communications link costs usually connected with a call-forwarding service are avoided.

In order to provide for an actual communications link between first end user unit EUU1 and third end user unit EUU3, telecommunications web site TCW establishes communications link 42 to first end user unit EUU1 and communications link 44 to third end user unit EUU3. Then, communications links 42 and 44 are connected by telecommunications web site TCW. The establishment of communications links 42 and 44 and the connecting of these two links is performed such that first end third end user units EUU1 and EUU3 are connected analogously to a conventional call-forwarding or conventional direct call. In an embodiment, telecommunications web site TCW includes an IVR (interactive voice response) system, available from a variety of manufacturers. Such an IVR system enables the creation and connecting of two calls. The IVR is controlled by software providing the necessary functionality.

As illustrated in FIG. 3, communications link 42 from telecommunications web site TCW to first end user unit EUU1 may be effected via switching unit SU1 (link 42A), switching unit SU2 (link 42B), directly between the telecommunications web site and the first end user unit (link 42), or combinations thereof. Similarly, communications link 44 from telecommunications web site TCW to third end user unit EUU3 may be effected via switching unit SU1 (link 44A), switching unit SU2 (link 44B), directly between the telecommunications web site and the first end user unit (link 44), or combinations thereof.

In the embodiments described with reference to FIGS. 4 and 5, the respective communications environment employs the SS7-INAP protocol, in which data characterizing a called end user unit is transmitted separate from content data and/or information, as described above.

FIG. 4 illustrates an embodiment wherein first end user unit EUU1 desires to establish a communications link with second end user unit EUU2. End user unit sends data characterizing end user unit EUU2 to switching unit SU over communications link 52.

Second end user unit EUU2 or its user has instructed switching unit SU to redirect, route, or forward, to telecommunications web site TCW incoming communications links for, or incoming requests to establish a communications link with, second end user unit EUU2. This instruction to switching unit SU may be referred to as a “routing directive.” Telecommunications web site TCW is associated with second end user unit EUU2. This routing directive by second end user unit EUU2 is for the purpose of providing management of communications. As in embodiments described above, the management of communications is here a monitoring of communications links. Such a monitoring of communications links may be desirable, for example, where a user of the second end user unit EUU2 is absent.

Second end user unit EUU2 or its user has instructed telecommunications web site TCW that incoming communications links intended for second end user unit EUU2 are to be routed to third end user unit EUU3. This routing request from end user unit EUU2 is provided to telecommunications web site TCW by an accessing of the web site by second end user unit EUU2 or its user. Second end user unit EUU2 and/or its user are authorized to access telecommunications web site TCW and input routing requests. The data characterizing end user unit EUU2 is forwarded from switching unit SU to telecommunications web site TCW over communications link 53 in accordance with the routing directive. To initiate the desired routing to third end user unit EUU3, switching unit SU is informed of the routing request. Telecommunications web site TCW therefore informs communications management unit MU over link 54 of the requested routing to third end user unit EUU3. Communications management unit MU communicates that request to communications control unit CU over link 56. Communications control unit CU in turn instructs switching unit SU over link 58 accordingly.

In this embodiment, communications management unit MU is an SMP and communications control unit CU is an SCP.

The routing request information is communicated from telecommunications web site TCW to communications management unit MU before a communications link to second end user unit EUU2 is requested. This is advantageous where communications between communications management unit MU and communications control unit CU are not real-time communications. The routing request may thereby be provided from telecommunications web site TCW early enough so that incoming communications links for second end user unit EUU2 are routed to third end user unit EUU3 with virtually no time delay.

Even where communications between communications management unit MU and communications control unit CU are not real-time, the routing request information can be communicated from telecommunications web site TCW to communications management unit MU in response to an incoming communications link from first end user unit EUU1. This is possible if transmissions between communications management unit MU and communications control unit CU are sufficiently fast. Transmission delays between communications control unit CU and switching unit SU may be small since the link between these units preferably provides real-time communications.

Where communications between telecommunications web site TCW and switching unit SU via communications management unit MU and communications control unit CU are real-time, in an embodiment telecommunications web site TCW communicates the routing request information in response to the data characterizing second end user unit EUU2 communicated from the first end user unit EUU1. Here, switching unit SU communicates this data to telecommunications web site TCW which, in turn, communicates the routing request information to the switching unit, as described above.

Switching unit SU is thus informed that communications links bound for second end user unit EUU2 are to be routed to third end user unit EUU3. Therefore, the attempt by first end user unit EUU1 to connect to second end user unit EUU2 results in a communications link being established between first end user unit EUU1 and third end user unit EUU3 via switching unit SU over communications links 52 and 59.

In contrast to the embodiment shown in FIG. 4, FIG. 5 illustrates an embodiment where telecommunications web site TCW is not in direct communication with switching unit SU. As with the embodiment illustrated in FIG. 4, telecommunications web site TCW is provided with the routing request directing that communications addressed for second end user unit EUU2 are to be routed instead to third end user unit EUU3. Telecommunications web site TCW transmits the routing request information via communications management unit MU and communications control unit CU to switching unit SU over communications links 62, 64 and 66.

Again, communication of the routing request information from telecommunications web site TCW to switching unit SU can be performed in advance or in response to first end user unit EUU1 attempting to establish a communications link to second user unit EUU2. To effect transmission of the routing request in advance, telecommunications web site TCW transmits relevant information to communications management unit MU upon receipt of the routing request from second end user unit EUU2.

As noted above, in an embodiment telecommunications web site TCW provides the routing request information to switching unit SU in response to the request by first end user unit EUU1 for a communications link to second end user unit EUU2. Here, second end user unit EUU2 is provided with information indicating that first end user unit EUU1 is attempting to establish a communications link with it. Second end user unit EUU2 accepts the data from first end user unit EUU1 characterizing second end user unit EUU2. Upon receipt of this data, second end user unit EUU2 informs telecommunications web site TCW of the communications link requested by first end user unit EUU1. This informing may be, for example, via the Internet, a Short Message Service (SMS) message, a telephone call, etc. Then, telecommunications web site TCW transmits to switching unit SU, via communications management unit MU and communications control unit CU, the routing request information to third end user unit EUU3 a communications link originating from first end user unit EUU1.

In an embodiment, to achieve a connection between first end user unit EUU1 and third end user unit EUU3, the characteristics of communications environment 50 may result in switching unit SU receiving the data characterizing second end user unit EUU2 but no actual communications link between first end user unit EUU1 and switching unit SU being established. In such an embodiment, switching unit SU establishes communications link 69 to third end user unit EUU3 and communications link 68 to first end user unit EUU1, and then connects these communications links to provide a communications link between the first and the third end user units.

In another embodiment, the capability to re-route communications links is provided. Such a re-routing results in an initial establishment of a communications link to second end user unit EUU2 from first end user unit EUU1. The re-routing may be accomplished, for example, via third end user unit EUU3, telecommunications web site TCW, switching unit SU, a second switching unit (not shown), or a combination or two or more of these. In an embodiment, re-routing to second end user unit EUU2 via switching unit SU is achieved by telecommunications web site TCW overruling the originally-requested routing. Rerouting may be accomplished by protocolling a communications link, e.g., a call, via telecommunications web site TCW even when end user unit EUU1 is called directly. Thus telecommunications web site TCW can provide a user with a telephone a record of calls received since the calls were routed through the telecommunications web site.

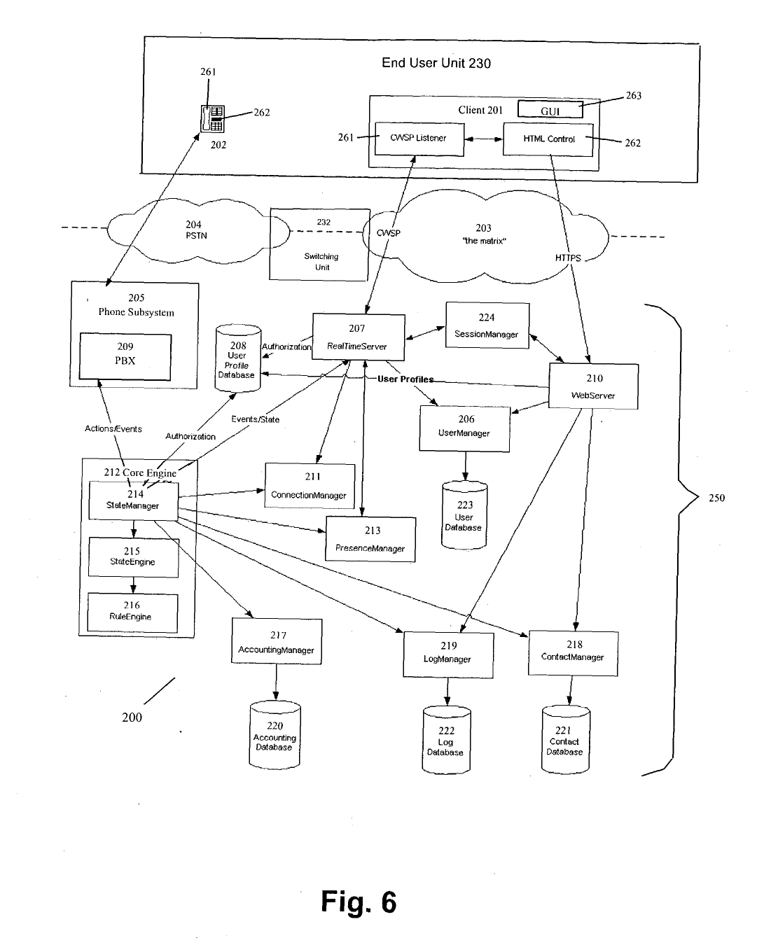

FIG. 6 shows the architecture of a communications environment 200 according to an embodiment of the present invention. Communications environment 200 includes telecommunications web site 250 and client 201, which communicate over matrix 203. Matrix 203 may be the Internet or an intranet, for example. Telephone 202 serves as an end user unit, communicating with telecommunications web site 250 over PSTN 204 to access phone subsystem 205. Telephone 202 may belong to the specific entity, i.e., the owner of telecommunications web site 250. Telephone 202 includes handset 261, which serves as an interface for user input and output, i.e., voice signals. Other telephones may serve as end user units for other called parties and/or users of telecommunications web site 250 and may likewise communicate over PSTN 204 and access phone subsystem 205. Network interface device 262 is also included in telephone 202 for interfacing with PSTN 204. In other embodiments of the present invention, other types of end user units that access telecommunications web site 250 over other types of networks or communications links may be provided.

Switching unit 232 may be a PSTN switching device for analog and/or digital telephone links, a network router, a radio base station, satellite-based relay unit, a transceiver, or any suitable communications-enabling device.

Client 201 provides a user interface for a user accessing telecommunications web site 250. The user may be any authorized user of telecommunications web site 250, including the specific entity. In an embodiment client 201 resides on a computing device of a user. In other embodiments client 201 may reside on other types of user communications devices. Where the user computing device is personal computer, client 201 may be a browser with a combination of, e.g., HTML code, Active-X components, JavaScript and/or an Java Applet. In another embodiment, client 201 is a stand-alone application. Using Active-X, Java or a stand-alone application enables active signaling to the client. A browser is only able to support “pull”-functionality, while an application supporting “push” functionality like “signaling that there is an incoming call” needs to be active listening on a communication port. Where the user computing device is a mobile phone or PDA client 201 may be implemented using, e.g., Java2 Micro Edition or Windows CE. For other user communication devices client 201 may be implemented using any language provided to develop applications for these devices.

More than one client 201 may be provided, each one corresponding to a given user. Client 201 includes CWSP listener module 261, HTML control module 262, and graphical user interface (GUI) 263. GUI 263 may be a browser-based graphical user interface including action buttons for clicking to perform actions. CWSP listener module 261 is a module which signals events (e.g., incoming call, new e-mail message, new fax, new visitor, etc.) to client 201. In an embodiment, the novel client-server signaling protocol described in European Patent Application No. 02 020 448.3, European attorney docket number 31536.WEB.P100EP, entitled “Signaling Protocol,” and hereby incorporated by reference herein, is used for communication between CWSP listener module 261 and real time server 207 (described below) of telecommunications web site 250. This novel signaling protocol, which will herein after be referred to as “signaling protocol CWSP,” provides for encryption (TLS 1.0/SSL 3.0) of datagrams with asymmetric handshake and symmetric session encryption, with no need for certificates from client 201. Signaling protocol CWSP provides for signaling of the following:

Login Handshake

Signaling of Line States with unique LINE-Ids, including ringing and hang-up

Initiate Line Actions, including call number and route incoming call to a number

Client State, including represent the general state of the application and signal the refresh of certain areas on the client

Keep-Alive

Logout

Time-Sync

Packet-Delay measurement to ensure fast data rate

Presence Information of contacts (Logon/Logoff/Break/.).

HTML control module 262 controls specific areas of the user interface and loads HTML pages into any controlled area on request by CWSP listener module 261. HTML control module 262 communicates with web server 210 (described below) of telecommunications web site 250. In an embodiment, HTML control module 262 is Microsoft Internet Explorer. Alternatively, HTML control module may be any other browser instance, such as Netscape Navigator or any other implementation of a browser. To ensure privacy of the communications between HTML control module 262 and web server 210, HTML control module 262 uses the protocol Hypertext Transfer Protocol over TLS (HTTPS), which is described in E. Rescorla, Memo, Network Working Group, “HTTPS Over TLS”, The Internet Society, 2000, which is hereby incorporated by reference herein.

Telecommunications web site 250 may includes a variety of components: phone subsystem 205, user manager 206, real time server 207, user profile database 208, web server 210, connection manager 211, core engine 212, presence manager 213, account manager 217, contact manager 218, log manager 219, and session manager 224. Some or all of the components of telecommunications web site 250 may be software components running on any of a variety of operating systems, such as any flavor of UNIX (BSD, Solaris, HP-UX, etc.), Linux, any Microsoft operating system (DOS, Windows 95, 98, NT, XP, ME, etc.), and any real time operating system (e.g., QNX, RTOS, EUROS, etc.), for example. Some or all of the components of telecommunications web site 250 may run on any of a variety of known or future computer hardware (e.g., Intel, AMD, HP, Sun, Motorola, IBM.). Some or all of the components of telecommunications web site 250 may be written in any of a variety of programming language, preferably any higher programming language such as C, Fortran, Basic, Pascal, Lisp, etc., or any higher object oriented programming language such as C++, Java, Python, etc., or any script language like Perl, PHP, etc., for example. Some or all of the components of telecommunications web site 250 may reside on the same hardware and may communicate via any suitable inter-process communication method provided by the operating system.

When any component of telecommunications web site 250 communicates with any other component not residing on the same hardware, the relevant components may use any of a variety of network communication protocols, such as, for example, CORBA, RPC, SOAP, RPC via SOAP, HTTP, FTP, etc. Communication between components of telecommunications web site 250 may be established via mounting of file systems and exchange of files. Some or all of the components of telecommunications web site 250 may exist in parallel multiple times so as to provide a scalable system for many, even several million users or more. In some embodiments of the present invention, several instances of the same component may be distributed on several different hardware devices. Hardware links between different hardware devices may be any of a variety of communications links, such as Ethernet, for example, or other network types, using any of a variety of interfaces, such as serial, parallel, etc.

Database components, such as user profile database 208, contact database 221 (discussed below), accounting database 220 (discussed below), log database 222 (discussed below), and user database 223 (discussed below), may be any of a variety of relational data bases, such as ORACLE, mySQL, etc., or object oriented databases, such as ‘Fast Objects’, an OQL database, XML Databases like dbXML, Tamino, X-Hive/DB, etc.

Phone subsystem 205 incorporates one or more private branch exchanges (PBX) 209. PBX 209 may include, for example, the Net@tec Phone Subsystem with NMS hardware, made by Net@tec. In an embodiment, phone subsystem 205, using PBX 209, provides the following functionality:

Signaling of incoming calls

Signaling of Phone Events (e.g. Ringing, Hang-up, Connect)

Signaling of DTFM

Creation of new Line Handles

Connection of 2 or more Line Handles for conferencing

Forwarding of incoming calls

User manager 206 receives login and password information and returns the corresponding user identification number if the combination is correct. In an embodiment, user manager 206 is a CORBA service providing functions for checking combinations of login name and password for their correctness. Alternatively, user manager 206 may be a service of another suitable protocol. User manager 206 communicates with user database 223 to check the login and password information and to locate the correct user identification number. User database 223 stores central user data, such as login, password and address information, for each user.

Real time server 207 is in one embodiment a CORBA service and a CORBA client with a CWSP listener interface so as to be able to communicate with clients 201 via signaling protocol CWSP and with other components of telecommunications web site 250 described below. Alternatively, real time server 207 may be a service and a client of another suitable protocol. Real time server 207 may reside on any suitable server hardware running on any suitable operating system In an embodiment, real time server 207 performs the following functions:

Sends all signals representing the current state of the system via signaling protocol CWSP to client 201.

Uses session manager 224 to share a session with web server 210. This ensures that the right combination of information is sent from real time server 207 and web server 210 to client 201. This ensures that no other user is able to access data of any other user.

Uses user profile database 208 to check the authorization level of a user. This is required because different users may have different contracts enabling them to use a different set of features of telecommunications web site 250.

Uses connection manager 224 to keep track of the lines (connections between phone subsystem 205 and any telephone) and logins of a given user. At any time the connection manager will know which lines on which PBX 209 and which logons on which instances of real time server 207 belong to a given user.

Uses presence manager 213 to keep track of the presence condition of any user.

Signals events to core engine 212 (e.g., the “call telephone number 00497219432940 button” was pressed on client 201), and receives information about the current state of the system from the core engine.

User profile database 208 holds user profiles containing information about the subscriber contract type, the user's telephones, personal settings and personal rules, invoices, permissions and the personal state graphs, which describe the behavior of the system at any given time.

Web server 210 provides all information displayed on client 201 that is not being transported by signaling protocol CWSP. In an embodiment, web server 210 is an Apache web server with the proper set of HTML pages and Scripting functionality for creating dynamic and personalized web pages using data retrieved from the other components via, e.g., IIOP (CORBA) or other suitable protocol. Alternatively, web server 210 may be an MS-IIS web server or any other suitable web server. In an embodiment, web server 210 provides the following functions:

Creates a Client Home Page with the personal greeting text, which is displayed using client 201.

Receives personal text messages from visitors of telecommunications web site 250 and organizes delivery of these messages to the owner of telecommunications web site 250, i.e., the specific entity.

Talks to user profile database 208 to display or to set the personal settings and personal texts.

Uses log manager 219 to create individual pages of personal log data. Log data is a record of all communication (incoming and outgoing) via telecommunications web site 250. Pages are subsets of this record (e.g., all emails, all communication to a specific contact) sorted by any criteria (date, subject, etc.)

Uses contact manger 216 to create individual lists of contacts and to store new contacts created on client 201.

Connection manager 211 enables the ability to get a connection between logons and current ongoing calls for a given user at a given time. In an embodiment, connection manager 211 is a CORBA service providing the functions described below. Alternatively, connection manager 211 may be a service of another suitable protocol. Connection manager 211 may reside on any of a variety of hardware, e.g., INTEL-based or AMD-based with any of a variety of operating systems, e.g., Linux or MS-Windows. For the user, or specific entity, there are several ways to get into contact with telecommunications web site 250. One of these ways is using client 201 on, e.g., a personal computer. To authorize his access, the specific entity types in his username and password and is then granted access to the telecommunications web site with certain privileges. This is called “logon”. The specific entity may be logged on from different systems at the same time. For an incoming telephone calls to the specific entity's telecommunications web site phone number, core engine 212 can access from connection manager 211 which system and with which address(es) the specific entity is logged on. This capability is advantageous for visualizing, on client 201, the current state (logons, connection details, etc.) of telecommunications web site 250. In an embodiment, connection manager 211 provides the following functionality:

Holds accounts of all logons and the associated real time server(s). Depending on the size of telecommunications web site 250, more than one real time server may be provided. A logon may be associated with a particular real time server.

Holds accounts of all ongoing calls and associated core engine(s). Depending on the size of telecommunications web site 250, more than one core engine may be provided. An ongoing call may be associated with a particular core engine.

It provides functions to find all real time server sessions and all core engines belonging to a specific entity.

Core engine 212 is a central component of telecommunications web site 250, and controls the current states of the telecommunications web site, and includes state manager 214, state engine 215 and rule engine 216. In an embodiment, core engine 212 is a CORBA service and CORBA client providing the functions described below. Alternatively, core engine 212 may be a service and client of another suitable protocol. Core engine 212 may reside on any of a variety of hardware, e.g., INTEL-based or AMD-based with any of a variety of operating systems, e.g., Linux or MS-Windows. In an embodiment, core engine 212 provides the following functions:

Uses several state managers 214 to communicate with user manager 206, real time server 207, user profile database 208, PBX 209, connection manager 211, presence manager 213, account manager 217, contact manager 218, and log manager 219.

Uses real time server 207 to signal events and the current state of the system to client 201; receives events from real time server 207.

Uses user profile database 208 to authorize calls and to retrieve user profile data for, for example, call forwarding functionality, time based change of profiles, checking of permissions, etc.

Uses phone subsystem 205 to initiate calls and conferences; and receives signals from phone subsystem 205 about incoming calls, hang-ups, DTFMs, etc.

Uses connection manager 211 to store information about current calls and to determine the respective real time server 207 instance to signal the state of each current call to.

Uses presence manager 213 to store current presence information for each user.

Uses accounting manager 217 to write call data records for accounting.

Uses contact manager 218 to identify calling numbers as known contacts. Depending on this identification the forwarding might be different. The specific entity can set profiles defining, for example, that a call from user A should always be forwarded to the secretary, while a call from user B should be forwarded to his mobile phone, if the call is within normal business hours. Thus, the reaction of telecommunications web site 250 can depend on the caller, etc.

Uses log manager 219 to write personal log records of calls.

Presence manager 213 is responsible for tracking the current presence status (offline, online, reachable, in break, in conference, etc.) of users. In an embodiment, presence manager 213 is a CORBA service providing the functions described below. Alternatively, presence manager 213 may be a service of another suitable protocol. Presence manager 213 may reside on any of a variety of hardware, e.g., INTEL-based or AMD-based with any of a variety of operating systems, e.g., Linux or MS-Windows. In an embodiment, presence manager 213 provides the following functionality:

Stores current presence information as set by real time server 207 and core engine 212.

Delivers the current presence information to real time server 207 and core engine 212.

State manager 214 of core engine 212 serves as the communicating part of core engine 212. State manager 214 is a subsystem of the core engine 212 and in an embodiment is a CORBA service providing the functions described below. Alternatively, state manager 214 may be a service of another suitable protocol. State manager 214 may reside on any of a variety of hardware, e.g., INTEL-based or AMD-based with any of a variety of operating systems, e.g., Linux or MS-Windows. In an embodiment of the present invention, state manager 214 may serve as a CORBA client and/or CORBA server for one or more of real time server 207, user profile database 208, PBX 209, connection manager 211, presence manager 213, account manager 217, contact manager 218, and log manager 219. In an embodiment, state manager 214 provides the following functionality:

Represents the current state of the system for real time server 207, user profile database 208, PBX 209, connection manager 211, presence manager 213, account manager 217, contact manager 218, and log manager 219.

Passes necessary information to state engine 215. For example, loads a user state graph from profile database 208 and passes the graph onto state engine 215.

Receives information from state engine 215 and initiates the appropriate calls of functions of real time server 207, user profile database 208, connection manager 211, presence manager 213, account manager 217, contact manager 218, and log manager 219.

State engine 215 uses the user state graph from user profile database 208 to move from one state to another; and executes the defined rules and triggers the appropriate actions, or events, via state manager 214. State engine 215 uses rule engine 216 to evaluate rules defined by the user, which are relevant to the current state. This evaluation process results in the next move by state engine 215 on the user state graph. State engine 215 thus provides a way to move on a user state graph and to control the behavior of telecommunications web site 250 according to the rules. In an embodiment, state engine 215 is software written in the C programming language. Alternatively, state engine 215 may be software written in any of a variety of other higher programming languages. State engine 215 may reside on any of a variety of hardware, e.g., INTEL-based or AMD-based with any of a variety of operating systems, e.g., Linux or MS-Windows.

Rule engine 216 provides evaluation of user defined rules stored in user profile database 208, including checking preconditions and deciding whether or not the rule must be applied. These rules provide actions associated with respective conditions. The specific entity can set profiles defining, for example, that a call from user A should always be forwarded to the secretary, while a call from user B should be forwarded to his mobile phone, if the call is within normal business hours. Thus, the reaction of telecommunications web site 250 can depend on the caller, etc. In an embodiment, rule engine 216 is software written in the C programming language. Alternatively, rule engine 216 may be software written in any of a variety of other higher programming languages. Rule engine 216 may reside on any of a variety of hardware, e.g., INTEL-based or AMD-based with any of a variety of operating systems, e.g., Linux or MS-Windows.

Accounting manager 217 receives accounting-relevant information, e.g., call data, records from state manager 214 which were created in state engine 215. In order to perform these tasks, accounting manager 217 provides an interface, e.g., CORBA, with functions to write and read accounting information. These call data records are then written into accounting database 220 for future processing, such as for billing purposes. In an embodiment, accounting manager 217 is software written in the C programming language. Alternatively, accounting manager 217 may be software written in any of a variety of other higher programming languages. Accounting manager 217 may reside on any of a variety of hardware, e.g., INTEL-based or AMD-based with any of a variety of operating systems, e.g., Linux or MS-Windows.

Contact manager 218 stores user contact data in contact database 221. User contact data may include, for example, title, first and last name, sex, date of birth, phone numbers, fax numbers, postal addresses, email addresses, etc. In an embodiment, contact manager 218 is a CORBA service that provides an interface with functions to store, retrieve, change and delete contact information. Alternatively, contact manager 218 may be a service of another suitable protocol. Contact manager 218 serves as an interface for storage and retrieval by web server 210, and retrieval by core engine 212, of contact data. In an embodiment, contact manager 218 is software written in the C programming language. Alternatively, contact manager 218 may be software written in any of a variety of other higher programming languages. Contact manager 218 may reside on any of a variety of hardware, e.g., INTEL-based or AMD-based with any of a variety of operating systems, e.g., Linux or MS-Windows.

Log manager 219 stores user log data in log database 222. User log data are records of communications of a given user, e.g.: “3.3.2002 17:01 Call from Frank—Duration 1:23”, “3.3.2002 17:15 Email to Frank—Size 69.345 Bytes”. In an embodiment, log manager 219 is a CORBA service that provides an interface with functions to store, retrieve, change and delete user log data. Alternatively, log manager 219 may be a service of another suitable protocol. In an embodiment, log manager 219 is software written in the C programming language. Alternatively, log manager 219 may be software written in any of a variety of other higher programming languages. Log manager 219 may reside on any of a variety of hardware, e.g., INTEL-based or AMD-based with any of a variety of operating systems, e.g., Linux or MS-Windows. In an embodiment, log manager 219 provides the following functionality:

Receives log data from core engine 212.

Answers requests for user log data from web server 210, returning the data in specifically filtered or sorted formats. An example of such a user log data request is a request for all calls from a special user within the last 2 months.

Allows certain requests from web server 210 to delete specific log data.

Allows certain requests from web server 210 to add documents to specific log data entries. Examples of such documents include a note about a given phone call, documents exchanged during a given phone call, etc.

Session manager 224 creates and stores a record of each user session. In an embodiment, session manager 224 is a CORBA service that provides an interface with functions to open, close and check a session. Alternatively, session manager 224 may be a service of another suitable protocol. In an embodiment, session manager 224 is software written in the C programming language. Alternatively, session manager 224 may be software written in any of a variety of other higher programming languages. Session manager 224 may reside on any of a variety of hardware, e.g., INTEL-based or AMD-based with any of a variety of operating systems, e.g., Linux or MS-Windows. In an embodiment, session manager 224 provides the following functionality:

Upon login via real time server 207 or via web server 210, creates a session and an associated unique session token. Since messages from client 201 to real time server 207 and web server 210 need a valid session token in order to be executed, real time server 207 and web server 210 check each request for the session token and request validation from session server 207.

Deletes a session after a defined time of inactivity.

It should be noted that telecommunications web site 250 is scaleable. Some or all of the above-described components may be duplicated several times, depending on the number of users and size of telecommunications web site 250.

The functioning of communications environment 200 will now be demonstrated by way of examples.

### EXAMPLE 1

FIGS. 2 and 6 may be used to demonstrate forwarding, or routing, of a communications link from first end user unit EUU1 originally intended for second end user unit EUU2 instead to third end user unit EUU3 using telecommunications web site TCW. End user unit EUU2 may be employed by a specific entity associated with telecommunications web site TCW. End user unit EUU1 desires to establish communications with end user unit EUU2. End user unit EUU2 has previously provided telecommunications web site TCW a routing directive indicating that incoming communications are to be routed to end user unit EUU3. Communications environment 200 in FIG. 6 corresponds to communications environment 10 in FIG. 2 and employs the SS7-ISUP protocol. Telecommunications web site 250 in FIG. 6 corresponds to telecommunications web site TCW in FIG. 2. End user unit 230 and switching unit 232 in FIG. 6 correspond to end user unit EUU2 and switching unit SU1, respectively, in FIG. 2.

In general, a user of end user unit EUU2 might use, e.g., the keys on a dial pad of end user unit EUU2 to enter a PIN for identification & authorization after calling the user's telecommunications web site TCW telephone number. The user then enters a telephone menu and activates the desired functions by typing a combination of numbers to identify the action (e.g., unconditional call forwarding UCF as described in SS7/ISUP) and parameters (e.g., a destination number) followed by, e.g., the ‘#’ to signal the end of the setup process. The telecommunications web site TCW then uses SS7/ISUP feature UCF to instruct switching unit SU1 to reroute any call originally intended for second end user unit EUU2 instead to third end user unit EUU3. The chain of events in communications environment 200 is as follows:

1. The user dials his telecommunications web site telephone number and his PIN on the dial pad of telephone 202 of end user unit EUU2.

2. The Phone Subsystem 205 gets the call signalized from switching unit SU1 in the PSTN 204 via DSS1 message SETUP and answers with ALERTING and CONNECT.

3. Switching unit SU1 answers with CONNECT ACKNOWLEDGE.

4. The Phone Subsystem 205 signalizes the connection to the Core Engine 212.

5. The Core Engine 212 loads the state graph of the user from the User Profile Database into the State Engine 215.

6. The State Engine 215 initiates the first announcement of the voice menu on the Phone Subsystem 205 via State Manager 214.

7. The user listens to the announcement, chooses an option and enters the number on the dial pad of telephone 202 of end user unit EUU2, e.g., 9 0721123456789#, where the 9 signalizes the unconditional call forwarding followed by the telephone number of end user unit EUU3 to forward to and completed by ‘#’ to signalize the end of the command.

8. The PBX 209 signalizes the number to the State Manager 214, which in turn asks the State Engine 215 how to proceed.

9. The State Engine 215 initiates a signal to the PBX 209 via State Manager 214 to send the signal UCF to the switching unit SU1 in the PSTN 204.

10. The PBX 209 in the Phone Subsystem 205 sends the command UCF to the switching unit SU1 in the PSTN 204 followed by a DSS1 signal DISCONNECT to the switching unit SU1.

11. The switching unit SU1 answers with RELEASE and PBX 209 finalizes the call by sending RELEASE COMPLETE following the DSS1 protocol.

### EXAMPLE 2

FIGS. 4 and 6 may be used to demonstrate forwarding, or routing, of a communications link from first end user unit EUU1 originally intended for second end user unit EUU2 instead to third end user unit EUU3 using telecommunications web site TCW. Here, communications environment 200 in FIG. 6, corresponding to communications environment 50 in FIG. 4, employs the SS7-INAP protocol and includes the communications management unit MU and the communications control unit CU. End user unit EUU2 may be employed by a specific entity associated with telecommunications web site TCW. End user unit EUU1 desires to establish communications with end user unit EUU2. End user unit EUU2 has previously provided telecommunications web site TCW a routing directive indicating that incoming communications are to be routed to end user unit EUU3. Telecommunications web site 250 in FIG. 6 corresponds to telecommunications web site TCW in FIG. 4. End user unit 230 and switching unit 232 in FIG. 6 correspond to end user unit EUU2 and switching unit SU, respectively, in FIG. 4.

In general, as described in Example 1 above, a user of end user unit EUU2 might use, e.g., the keys on a dial pad of end user unit EUU2 to enter a PIN for identification & authorization after calling the user's telecommunications web site TCW telephone number. The user then enters a telephone menu and activates the desired functions by typing a combination of numbers to identify the action (e.g., unconditional call forwarding UCF as described in SS7/ISUP) and parameters (e.g., a destination number) followed by, e.g., the ‘#’ to signal the end of the setup process. The telecommunications web site TCW then informs the central database used by INAP about the rerouting following the procedures described in ETSI-Standard ETS 300 374-1. INAP and the central database are defined and described in ITU-T Q.1200 and in the ETSI documents ETS 300 374-x and ETS 301 140-x. In an embodiment, connection of the telecommunications web site TCW to the central database is provided via the Internet using TCP/IP and ODBC (Open Database Connectivity). Alternatively, any suitable network and protocol could be use. The INAP central database and associated software serve as the communications management unit MU and communications control unit CU shown in FIG. 4. The chain of events in communications environment 200 is as follows:

1. The user dials his telecommunications web site telephone number and his PIN on the dial pad of telephone 202 of end user unit EUU2.

2. The Phone Subsystem 205 gets the call signalized from switching unit SU1 in the PSTN 204 via DSS1 message SETUP and answers with ALERTING and CONNECT.

3. Switching unit SU answers with CONNECT ACKNOWLEDGE.

4. The Phone Subsystem 205 signalizes the connection to the Core Engine 212.

5. The Core Engine 212 loads the state graph of the user from the User Profile Database into the State Engine 215.

6. The State Engine 215 initiates the first announcement of the voice menu on the Phone Subsystem 205 via State Manager 214.

7. The user listens to the announcement, chooses an option and enters the number on the dial pad of telephone 202 of end user unit EUU2, e.g., 9 0721123456789#, where the 9 signalizes the unconditional call forwarding followed by the telephone number of end user unit EUU3 to forward to and completed by ‘#’ to signalize the end of the command.

8. The PBX 209 signalizes the number to the State Manager 214, which in turn asks the State Engine 215 how to proceed.

9. The State Engine 215 initiates a signal UCF, following the procedures described in ETSI-Standard ETS 300 374-1, to the central database used by INAP via State Manager 214.

10. The PBX 209 in the Phone Subsystem 205 sends the DSS1 signal DISCONNECT to the switching unit SU.

11. The switching unit SU answers with RELEASE and PBX 209 finalizes the call by sending RELEASE COMPLETE following the DSS1 protocol.

In the preceding specification, the present invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method for managing communications, comprising:
communicating from a first end user unit data indicating a second end user unit and configured to initiate a communications link with the second end user unit; and
routing the data indicating the second end user unit to a web site associated with the second end user unit.

2. The method as recited in claim 1 wherein the web site is a telecommunications web site associated with the second end user unit.

3. The method as recited in claim 1 further comprising storing the data indicating the second end user unit using the web site.

4. The method as recited in claim 1 further comprising defining, using the second end user unit, a routing directive for the routing the data indicating the second end user unit to the web site.

5. The method as recited in claim 4 wherein the defining the routing directive and the routing the data are performed using a first switching unit.

6. The method as recited in claim 1 further comprising receiving at a first switching unit the data indicating the second end user, and wherein the routing the data indicating the second end user is performed by communicating the data indicating the second end user unit from the first switching unit to the web site.

7. The method as recited in claim 1 further comprising:
directing, using the second end user unit, that communications links are to be forwarded to a third end user unit; and
establishing a communications link from the first end user unit to the third end user unit using the web site.

8. The method as recited in claim 7 wherein the directing is performed using an accessing of the web site by the second end user unit.

9. The method as recited in claim 7 further comprising:
storing the data indicating the second end user unit;
replacing the data indicating the second end user unit with data indicating a third end user unit; and
establishing a communications link from the first end user unit to the third end user unit using the web site.

10. The method as recited in claim 9 wherein the storing the data indicating the second end user unit is performed by storing the data at a first switching unit using the web site and wherein the establishing the communications link is performed via the first switching unit.

11. The method as recited in claim 10 wherein the establishing the communications link is performed via a second switching unit.

12. The method as recited in claim 1 further comprising:
directing, using the second end user unit, that communications links are to be forwarded to the third end user unit;
obtaining data indicating the first end user unit using the web site;
establishing a first communications link to the first end user unit using the web site;
establishing a second communications link to a third end user unit using the web site; and
connecting the first communications link with the second communications link using the web site so as to establish a third communications link between the first and third end user units.

13. The method as recited in claim 12 further comprising storing the data indicating the second end user unit using the web site, and wherein the obtaining the data indicating the first end user unit and the establishing the second communications link are performed via the first switching unit.

14. The method as recited in claim 12 wherein the establishing the first communications link and the establishing the second communications link are performed via a second switching unit.

15. The method as recited in claim 1 further comprising:
receiving at a switching unit the data indicating the second end user unit;
communicating data indicating a third end user unit from the web site to the switching unit, the third end user unit being an end user unit to which communications intended for the second end user unit are to be routed; and
replacing the data indicating the second end user unit with data indicating the third end user unit using the switching unit so as to establish a communications link from the switching unit to the third end user unit.

16. The method as recited in claim 15 wherein the communicating the data indicating the third end user unit from the web site to the switching unit is performed before the communicating from the first end user unit the data indicating the second end user unit.

17. The method as recited in claim 15 wherein the communicating the data indicating the third end user unit from the web site to the switching unit is performed is response to the communicating from the first end user unit the data indicating the second end user unit.

18. The method as recited in claim 15 further comprising:
establishing a first communications link from the switching unit to the first end user unit;
establishing a second communications link from the switching unit to the third end user unit; and
connecting the first communications link with the second communications link so as to establish a third communications link between the first and third end user units.

19. The method as recited in claim 15 wherein the communicating the data indicating the third end user unit from the web site to the switching unit is performed by:
communicating the data indicating the third end user unit from the web site to a communications control unit configured to control communications links between end user units; and
communicating the data indicating the third end user unit from the communications control unit to the switching unit so as to control the replacing upon a receipt by the switching unit of the data indicating the second end user unit.

20. The method as recited in claim 15 wherein the communicating the data indicating the third end user unit from the web site to a switching unit is performed by:
communicating the data indicating the third end user unit from the web site to a communications management unit, the communications management unit being configured to control a communications control unit;
communicating the data indicating the third end user unit from the communications management unit to the communications control unit configured to control communications links between end user units; and
communicating the data indicating the third end user unit from the communications control unit to the switching unit so as to control the replacing upon a receipt by the switching unit of the data indicating the second end user unit.

21. The method as recited in claim 15 wherein the communicating the data indicating the third end user unit from the web site to the switching unit is performed in real time.

22. A web site for managing communications, comprising:
a web page associated with a user of a second end user unit; and
a processor configured to receive data indicating the second end user unit, the data being communicated from a first end user unit and configured to initiate a communications link with the second end user unit.

23. The web site as recited in claim 22 wherein the web site is a telecommunications web site associated with the second end user unit.

24. The web site as recited in claim 22 wherein the processor is configured to initiate a storing of the data indicating the second end user unit.

25. The web site as recited in claim 22 wherein the second end user unit is configured to define a routing directive to route the data indicating the second end user unit to the web site.

26. The web site as recited in claim 22 wherein the processor is configured to receive the data indicating the second end user unit via a first switching unit.

27. The web site as recited in claim 22 wherein the processor is configured to establish a communications link from the first end user unit to a third end user unit, the third end user unit being designated by the second end user unit to receive communications links destined for the second end user unit.

28. The web site as recited in claim 22 wherein the processor is configured to store the data indicating the second end user unit and to establish the communications link via a first switching unit.

29. The web site as recited in claim 22 wherein the processor is configured to:
receive a directive by the second end user unit that communications links destined for the second end user unit are to be forwarded to a third end user unit;
establish a first communications link to the first end user unit;
establish a second communications link to the third end user unit; and
connect the first communications link with the second communications link so as to establish a third communications link between the first and third end user units.

30. The web site as recited in claim 22 wherein the processor is configured to communicate to a switching unit data indicating a third end user unit, the third end user unit being an end user unit to which communications intended for the second end user unit are to be routed, the data indicating the second end user unit being replaced in the switching unit with data indicating the third end user unit so as to establish a communications link from the switching unit to the third end user unit.

31. The web site as recited in claim 30 wherein the processor is configured to communicate the data indicating the third end user unit to the switching unit in real time.

32. A communications control unit comprising a processor configured to:
control communications links between end user units;
receive from a web site data indicating the third end user unit, the third end user unit being an end user unit to which communications intended for a second end user unit are to be routed; and
communicate the data indicating the third end user unit to a switching unit, the switching unit being configured to receive data indicating the second end user unit and replace the data indicating the second end user unit with data indicating the third end user unit so as to establish a communications link from the switching unit to the third end user unit.

33. The communications control unit as recited in claim 32 wherein the processor is part of a service control point of an intelligent network.

34. A communications management unit comprising a processor configured to:
control a communications control unit configured to control communications links between end user units and to communicate to a switching unit data indicating a third end user unit, the third end user unit being an end user unit to which communications intended for a second end user unit are to be routed, the switching unit being configured to receive data indicating the second end user unit and replace the data indicating the second end user unit with data indicating the third end user unit so as to establish a communications link from the switching unit to the third end user unit;
receive from a web site the data indicating the third end user unit; and
communicate the data indicating the third end user unit to the communications control unit switching unit.

35. The communications management unit as recited in claim 34 wherein the processor is part of a service management point of an intelligent network.

36. A computer readable medium having stored thereon computer executable process steps operative to perform a method for managing communications comprising:
communicating from a first end user unit data indicating a second end user unit and configured to initiate a communications link with the second end user unit; and
routing the data indicating the second end user unit to a web site associated with the second end user unit.

37. The computer readable medium as recited in claim 36 wherein the web site is a telecommunications web site associated with the second end user unit.

38. The computer readable medium as recited in claim 36 wherein the method further comprises storing the data indicating the second end user unit using the web site.

39. The computer readable medium as recited in claim 36 wherein the method further comprises defining, using the second end user unit, a routing directive for the routing the data indicating the second end user unit to the web site.

40. The computer readable medium as recited in claim 36 wherein the method further comprises receiving at a first switching unit the data indicating the second end user, and wherein the routing the data indicating the second end user is performed by communicating the data indicating the second end user unit from the first switching unit to the web site.

41. The computer readable medium as recited in claim 36 wherein the method further comprises:
directing, using the second end user unit, that communications links are to be forwarded to a third end user unit; and
establishing a communications link from the first end user unit to the third end user unit using the web site.
